(19) United States
(12) Patent Application Publication
(10) Pub. No.: US 2011/0196752 A1
(43) Pub. Date: Aug. 11, 2011

(54) METHOD AND SYSTEM FOR ORGANIZING INFORMATION WITH SHARABLE USER INTERFACE

(75) Inventors: Xavier Paulik, Saint-Maur-des-Fosses (FR); Dimitri Singer, Paris (FR); Laurent Guyot-Sionnest, Paris (FR)

(73) Assignee: TIKILABS, Paris (FR)

(21) Appl. No.: 13/023,393

(22) Filed: Feb. 8, 2011

Related U.S. Application Data
(60) Provisional application No. 61/303,113, filed on Feb. 10, 2010.

(51) Int. Cl. G06F 3/048; G06Q 30/00

(52) U.S. Cl. 705/14.73; 715/760

(57) ABSTRACT

A method, including: displaying, within a user interface (UI), a first grid having a first plurality of key zones corresponding to a first plurality of objects; identifying a selection of a first key zone in the first plurality of key zones corresponding to an object of the first plurality of objects; displaying, in response to the selection of the first key zone, a second grid having a second plurality of key zones corresponding to a second plurality of objects, where the object of the first plurality of objects is associated with the second grid; receiving a first selection of a second key zone in the second plurality of key zones; and displaying, in response to the first selection of the second key zone, a first preview of a first web page with the second grid, where the first web page corresponds to an object in the second plurality of objects.

### CROSS-REFERENCE TO RELATED APPLICATIONS

This patent application claims priority under 35 U.S.C. §119(e) to U.S. Provisional Patent Application Ser. No. 61/303,113, entitled: “Method and System for Organizing Information with a Sharable User Interface,” and filed on Feb. 10, 2010, in the names of the same inventors as the present patent application. U.S. Provisional Patent Application Ser. No. 61/303,113 is incorporated herein by reference in its entirety.

### BACKGROUND

In the digital convergence and the multi-screen era, users need to browse and access more and more information, using various devices which may have much less resources than a regular desktop with a big screen, a full keyboard, a fast pointer and a strong broadband internet link. Mobile devices are typical of that resources scarcity but also the connected TV and many others. The information browsed and accessed may be of any type and may come from any source, but are very often built and conceived for the desktop. Then, it is often difficult to organize, access and share this vast amount of information with the constraints (e.g. reduced screen size, distant screen, handheld remote) of the growing array of other devices.

### SUMMARY

In general, in one aspect, the invention relates to a method. The method comprises: displaying, within a user interface (UI), a first grid comprising a first plurality of key zones corresponding to a first plurality of objects; identifying a selection of a first key zone in the first plurality of key zones corresponding to an object of the first plurality of objects, wherein the selection of the first key zone is a first type of selection; displaying, within the UI and in response to the selection of the first key zone, a second grid comprising a second plurality of key zones corresponding to a second plurality of objects, wherein the object of the first plurality of objects is associated with the second grid; receiving a first selection of a second key zone in the second plurality of key zones, wherein the first selection of the second key zone is a second type of selection; and displaying, within the UI and in response to the first selection of the second key zone, a first preview of a first web page with the second grid, wherein the first web page corresponds to an object in the second plurality of objects.

In general, in one aspect, the invention relates to a non-transitory computer readable storage medium storing instructions. The instructions comprise functionality for: displaying, within a user interface (UI), a first grid comprising a first plurality of key zones corresponding to a first plurality of objects; identifying a selection of a first key zone in the first plurality of key zones corresponding to an object of the first plurality of objects, wherein the selection of the first key zone is a first type of selection; displaying, within the UI and in response to the selection of the first key zone, a second grid comprising a second plurality of key zones corresponding to a second plurality of objects, wherein the object of the first plurality of objects is associated with the second grid; receiving a first selection of a second key zone in the second plurality of key zones, wherein the first selection of the second key zone is a second type of selection; and displaying, within the UI and in response to the first selection of the second key zone, a first preview of a first web page with the second grid, wherein the first web page corresponds to an object in the second plurality of objects.

In general, in one aspect, the invention relates to a system. The system comprises: a grid repository storing a first grid comprising a first plurality of key zones corresponding to a first plurality of objects and a second grid comprising a second plurality of key zones corresponding to a second plurality of objects; a user event listener configured to identify a selection of a first key zone in the first plurality of key zones and a selection of a second key zone in the second plurality of key zones, wherein the selection of the first key zone is a first type of selection, and wherein the selection of the second key zone is a second type of selection; and a grid engine configured to display the second grid in response to the selection of the first key zone and to display a preview for a web page in response to the selection of the second key zone, wherein the second grid corresponds to an object in the first plurality of objects, and wherein the web page corresponds to an object in the second plurality of objects.

Other aspects of the invention will be apparent from the following description and the appended claims.

### BRIEF DESCRIPTION OF DRAWINGS

FIG. 1 shows an example grid in accordance with one or more embodiments of the invention.

FIG. 2 shows a block diagram depicting a system in accordance with one or more embodiments of the invention.

FIGS. 3-5 show flowcharts in accordance with one or more embodiments of the invention.

FIGS. 6-9 show grid navigation examples and/or grid functionality examples in accordance with one or more embodiments of the invention.

FIG. 10 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a system and method for organizing information within a sharable user interface. Specifically, there exists a hierarchy (i.e., tree or deck) of grids available for traversal-navigation by the user. Each grid has one or more key zones corresponding to one or more objects (e.g., files, user software applications, commands, maps, advertisements, web pages, web sites, child grids in the hierarchy, etc.). Following a selection of a key zone, the object corresponding to the key zone is launched and/or a preview of the object corresponding to the key zone is displayed. A user can create custom grids, merge (e.g., concatenate) two or more existing grids, import/export/share grids, etc. Further, a web site may use grids having key zones to control viewing and/or navigation of the content within the web site.

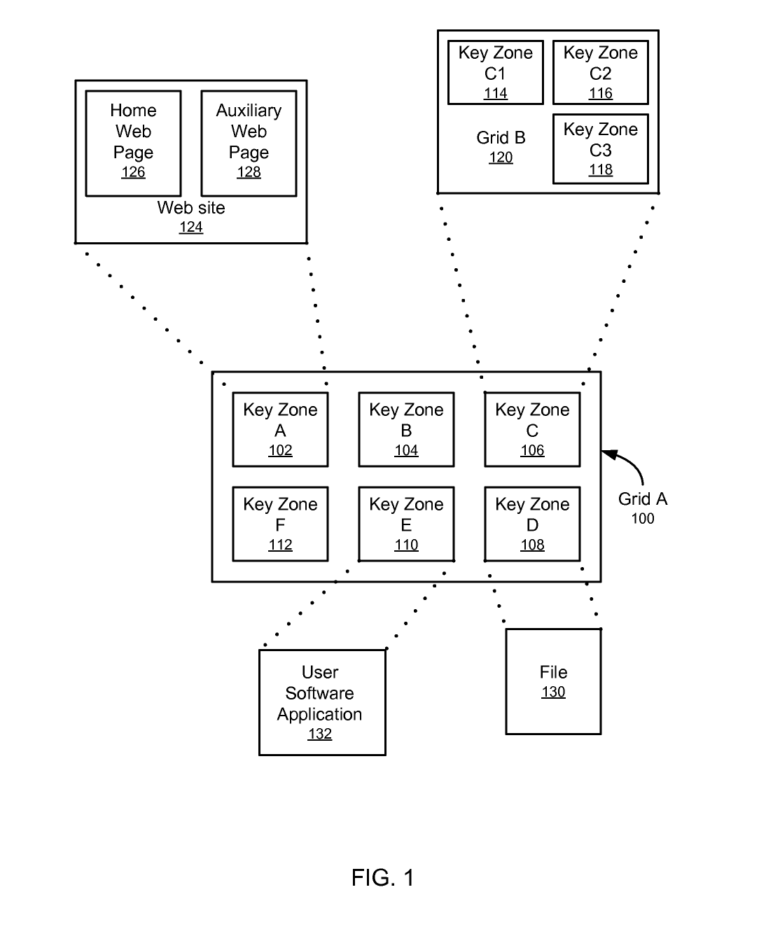

FIG. 1 shows a grid (i.e., Grid A (100)) in accordance with one or more embodiments of the invention. Grid A (100) may be displayed within a user interface (e.g., a touch screen of a mobile device). As shown in FIG. 1, Grid A (100) has multiple key zones (i.e., Key Zone A (102), Key Zone B (104), Key Zone C (106), Key Zone D (108), Key Zone E (110), Key Zone F (112)). The key zones correspond to areas/regions of Grid A (100) that are selectable by the user. Further, each key zone (102, 104, 106, 108, 110, 112) also corresponds to an object (discussed below).

In one or more embodiments of the invention, an object is launched or a preview of the object is displayed depending on how the corresponding key zone is selected. In other words, it is the type of selection or the manner in which the key zone is selected that governs the actions performed on the corresponding object. For example, pressing and holding a key zone (i.e., key zone hold) for a predetermined duration (e.g., 1.5 seconds) is a type of selection. In fact, pressing and holding a key zone for different durations (e.g., 1.5 seconds vs. 5 seconds) may correspond to different types of selections. As yet another example, releasing a key zone (after pressing and holding the key zone) (i.e., key zone release) is a type of selection. Further, selections made by a pointing device (e.g., mouse, track ball, pen, stylus, etc.), by a keyboard/keypad, or by a voice command may all correspond to different types of selections. Further still, a timer may serve as a selection mechanism. Specifically, if a pre-determined amount of time has elapsed and the user has not made a selection, previews for the objects may be generated and displayed in a sequence, with each preview being displayed for a pre-determined amount of time before the next preview in the sequence is generated and/or displayed. Those skilled in the art, having the benefit of this detailed description, will appreciate that many selection types exist in addition to those explicitly mentioned.

As shown in FIG. 1, Key Zone E (110) corresponds to a user software application (132) (e.g., a word processing application, a web browser, an accounting application, a desktop publishing application, a spreadsheet application, a social networking application, etc.). Accordingly, the user software application (132) may be launched (i.e., executed) in response to a selection of Key Zone E (110). Alternatively, a preview of the user software application (132) may be generated and/or displayed in response to a selection of Key Zone E (110). The preview may include a screen shot of the user software application (132) and/or various attributes of the user software application (132) (e.g., size, availability, installation date/time, last executed date/time, last updated date/time, etc.). Whether a preview is displayed or whether the user software application (132) is launched depends on the manner in which Key Zone E (110) is selected (i.e., the type of selection).

As shown in FIG. 1, Key Zone D (108) corresponds to a file (130) (i.e., a document, an image or photograph, a spreadsheet, a slideshow, etc.). Accordingly, the file (130) may be launched (e.g., displayed) (either inside the application that generated the file (130) or an application that can view the file (130)) in response to a selection of Key Zone D (108). Alternatively, a preview of the file (130) may be displayed in response to a selection of Key Zone D (108). The contents of the preview may depend on the type of the file (130). For example, in the case of images or photographs, the preview may include a portion of the file and/or a low-resolution version of the file (130). In the case of word processing documents, the preview may include the headers and/or cover page of the document. The preview may also include attributes of the file (e.g., date/time created, date/time last modified, size, storage location, etc.). Whether a preview of the file (130) is displayed or whether the file (130) itself is launched depends on the manner in which Key Zone D (108) is selected (i.e., the type of selection). In one or more embodiments of the invention, an entire grid corresponds to a file. In such embodiments, each key zone corresponds to a different view or different part of the file (e.g., table of contents, summary, index, list of figures, etc.). Accordingly, the grid is effectively a grid of contents of the file.

Still referring to FIG. 1, Key Zone A (102) corresponds to a web site (124) having a home web page (126) and an auxiliary web page (128). Accordingly, the home web page (126) of the web site (124) may be launched in response to a selection of Key Zone A (102). Alternatively, a preview of the home web page (126) may be displayed in response to a selection of Key Zone A (102). The preview may correspond to a cached version of the home web page (126). Further, the preview may include only a portion of the home web page (126) and/or a low resolution version of the web page. Whether a preview of the home web page (126) is displayed or whether the home web page (126) is launched depends on the manner in which Key Zone A (102) is selected (i.e., the type of selection).

Still referring to FIG. 1, Key Zone C (106) corresponds to Grid B (120) having multiple key zones (i.e., Key Zone C1 (114), Key Zone C2 (116), Key Zone C3 (118)). The multiple key zones (114, 116, 118) of Grid B (120) also correspond to one or more types of objects (i.e., web pages, child grids, user software applications, commands, maps, advertisements, files, etc.) (not shown). Grid B (120) may be launched (i.e., displayed) in response to a selection of Key Zone C (106). Alternatively, a preview of Grid B (120) may be displayed in response to a selection of Key Zone C (106). The preview may include a scaled (i.e., smaller sized) version of Grid B (120). Whether a preview of Grid B (120) is displayed or whether Grid B (120) is launched depends on the manner in which Key Zone C (106) is selected (i.e., the type of selection).

In one or more embodiments of the invention, Grid A (100) and Grid B (120) correspond to different levels within a hierarchy (i.e., tree or deck) of grids. Specifically, Grid B (120) is a child grid of Grid A (100) within the hierarchy of grids. Similarly, Grid A (100) is a parent grid of Grid B (120) within the hierarchy of grids. Further, Grid A (100) may be a child grid of another grid (not shown) in the hierarchy of grids. The hierarchy or tree of grids may have any number of levels. A user may traverse the hierarchy of grids by selecting key zones that correspond to grids of a different level within the hierarchy. Grids on the bottom of the hierarchy (i.e., grids that have no child grids) may be referred to as “leaf grids”. In contrast, grids that are not “leaf grids” may be referred to as “interior grids.” In one or more embodiments of the invention, all key zones of interior grids correspond to grids (i.e., child grids). Accordingly, in such embodiments of the invention, only leaf grids have key zones corresponding to objects other than grids (e.g., files, web pages, commands, maps, advertisements, user software applications, etc.).

In one or more embodiments of the invention, the key zones (102, 104, 106, 108, 110, 112) include icons, images, text, video clips, and/or animation associated with their corresponding objects. One or more key zones may be animated in an attempt to attract the user's attention. The animation may occur immediately following display of the grid or following a pre-determined amount of time during which there has been no selection made by the user. Further, the key zones corresponding to grids (e.g., Key Zone C (106)) may display density statistics regarding one or more levels of the hierarchy below the current grid. For example, the density statistics may include the number of levels in the hierarchy below the current grid, the mean or median number of key zones in the child grids below the current grid, etc. Further still, either the key zones themselves or areas in close proximity to the key zones (i.e., above, beside, below the key zones) may display indications relating to the objects of novelties, unread content, paths through the grid hierarchy already explored or not yet explored, etc. Those skilled in the art, having the benefit of this detailed description, will appreciate that the last level of each path in a grid may be different. In other words, some paths may be less than a dozen levels deep. Other paths may be over twenty five levels deep.

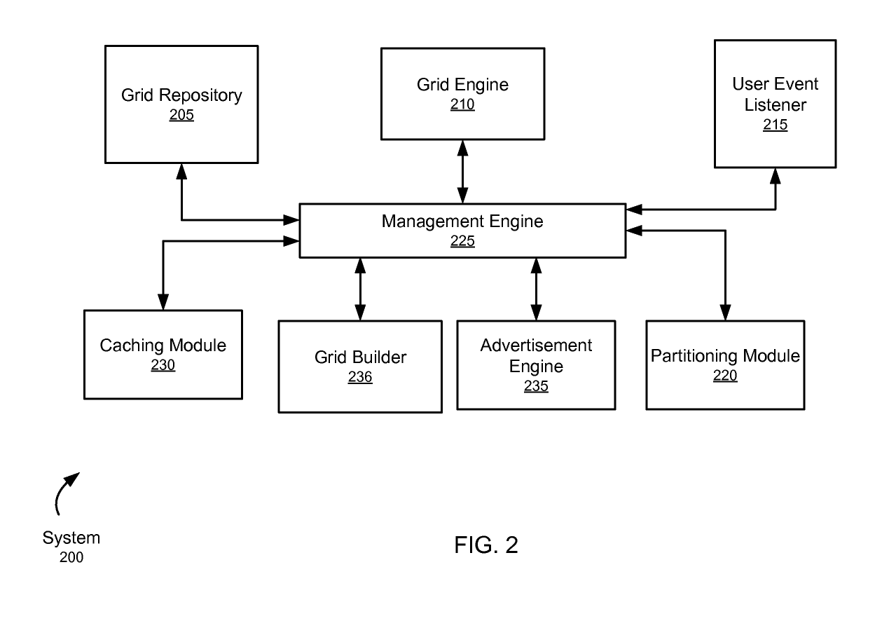

FIG. 2 shows a system (200) in accordance with one or more embodiments of the invention. As shown in FIG. 2, the system (200) has multiple components including a grid repository (205), a grid engine (210), a user event listener (215), a partitioning module (220), a caching module (230), an advertisement engine (235), a grid builder (236), and a management engine (225). Each of these components are described below and may be located on the same hardware device (e.g., a server, mainframe, desktop personal computer (PC), laptop, personal digital assistant (PDA), television, cable box, satellite box, kiosk, smart phone, etc.) or may be located on separate hardware devices connected by a network (e.g., the Internet), with wired and/or wireless segments.

In one or more embodiments of the invention, the grid repository (205) stores grids (e.g., Grid A (100) and Grid B (120), discussed above in reference to FIG. 1). Further, the grid repository (205) may store multiple related grids as a tree or other type of hierarchical structure. The grids stored in the grid repository (205) may be custom grids created by users, grids provided by web sites, and/or grids provided by third-parties. Further, each grid in the grid repository (205) may be referenced (i.e., indexed) by providing a uniform resource locator (URL), a 1-dimensional (1D) and/or 2-dimension (2D) bar code, or another type of key.

In one or more embodiments of the invention, the user event listener (215) identifies selections made by the user while the user is navigating one or more grids. Specifically, the user event listener (215) identifies key zones selected by the user and the manner(s) in which the key zones are selected (i.e., selection types). As yet another example, the event listener (215) includes a timer to identify pre-determined amounts of time during which the user has not made a key zone selection even though a grid is displayed. Accordingly, the user event listener (215) is operatively connected to the user interface (e.g., a touch screen) of the hardware device being operated by the user. Further, the user event listener (215) may track and record user selection patterns within a grid or hierarchy of grids. Further still, the user event listener (215) may match current user behavior, a set of user defined parameters or the current geographic location (i.e., geographic coordinates) of the user, to one or more recorded patterns in order to predict subsequent key zone selections made by the user or propose displays of interest to the user.

In one or more embodiments of the invention, the grid engine (210) is configured to retrieve and launch grids (e.g., grids in the grid repository (205), grids provided by web sites or web pages, etc.); retrieve, generate, and/or display previews for objects corresponding to key zones in the grids; launch web pages corresponding to key zones; launch software applications corresponding to key zones; launch files corresponding to key zones; launch other objects corresponding to key zones; etc. Specifically, the grid engine (210) is triggered by the events (i.e., user key zones selections and type of selections) identified by the user event listener (215). In other words, the grid engine (210) executes one or more of the mentioned actions in response to user key zones selections and the type of selections. Further, the grid engine (210) is operatively connected to the user interface (e.g., a touch screen of a mobile device) being operated by the user and has access to the objects corresponding to the key zones in the grids.

In one or more embodiments of the invention, the caching module (230) is configured to access and cache web pages and/or web sites corresponding to key zones on one or more grids (e.g., grids in the grid repository (205)). The cached web pages may be used to generate previews for the web pages and/or web sites. In one or more embodiments of the invention, the web pages and/or web sites selected for caching correspond to key zones that are likely (i.e., predicted) to be selected by the user. For example, when a preview for a grid is displayed, the caching module (230) may access and cache all web sites and/or web pages corresponding to key zones in the grid, in anticipation of the user launching the grid and selecting one or more of said key zones. As yet another example, while a grid is being displayed, the caching module (230) may periodically (or randomly) access and cache the web sites and/or web pages corresponding to key zones on the grid. Further still, once the current user behavior is matched to a known user pattern (e.g., by the user event listener (215)), the web pages and/or web sites corresponding to key zones predicted as likely to be selected may be accessed and cached.

In one or more embodiments of the invention, the partitioning module (220) is configured to partition and format a web page into various panels. In one or more embodiments of the invention, each panel is sufficiently small to fit within the user interface (e.g., touch screen) of the user device. In other words, the dimensions of each panel are smaller than the dimensions of the user interface. In one or more embodiments of the invention, the boundary (i.e., perimeter) of each panel is specified using tags within the markup language (e.g., HTML, XML) describing the web page. Once the web page is launched (i.e., in response to a selection of a key zone corresponding to the web page), the partitioning module (220) partitions the web page according to the tags. Further, each panel is assigned to a key zone in a grid for the web page. A panel may be viewed by selecting its corresponding key zone in the grid.

In one or more embodiments of the invention, the advertisement engine (235) is configured to select an advertisement for populating a key zone of a grid (e.g., Grid A (100), Grid B (120), etc.). The advertisement may be an image, an animation, a video clip, an audio clip, and/or a link to a web site, etc. Selection of the key zone may launch the advertisement. The advertisement engine (235) may select advertisements based on any criteria, including content previously accessed by the user, search requests issued by the user, etc.

In one or more embodiments of the invention, the grid builder (236) is configured to generate grids (e.g., Grid A (100), Grid B (120)) and/or a hierarchy (i.e., tree or deck) of grids. Specifically, the grid builder (210) is configured to generate grids by importing existing grids (e.g., from third-parties) selected by the user and merging (e.g., concatenating) portions of the existing grids and/or by assigning objects (e.g., software applications, files, web pages, advertisements, web sites, panels (discussed below), commands, maps, filter criteria, other grids, etc.) selected by the user to key zones of one or more grids. Further, the grid builder (236) is also configured to populate the key zones of a grid with icons (i.e., images, clipart, labels, etc.) selected by the user and representing the corresponding objects assigned to the key zones. Accordingly, the grid builder (236) provides an interface through which user selections/input are collected.

In one or more embodiments of the invention, the management engine (225) provides a link between the grid repository (205), the grid engine (210), the user event listener (215), the caching module (230), the partitioning module (220), the advertisement engine (235), and the grid builder (236). The management engine (225) may be configured to convert data or commands from one format to another format in order to render the components (205, 210, 215, 220, 230, 235, 236) compatible with each other.

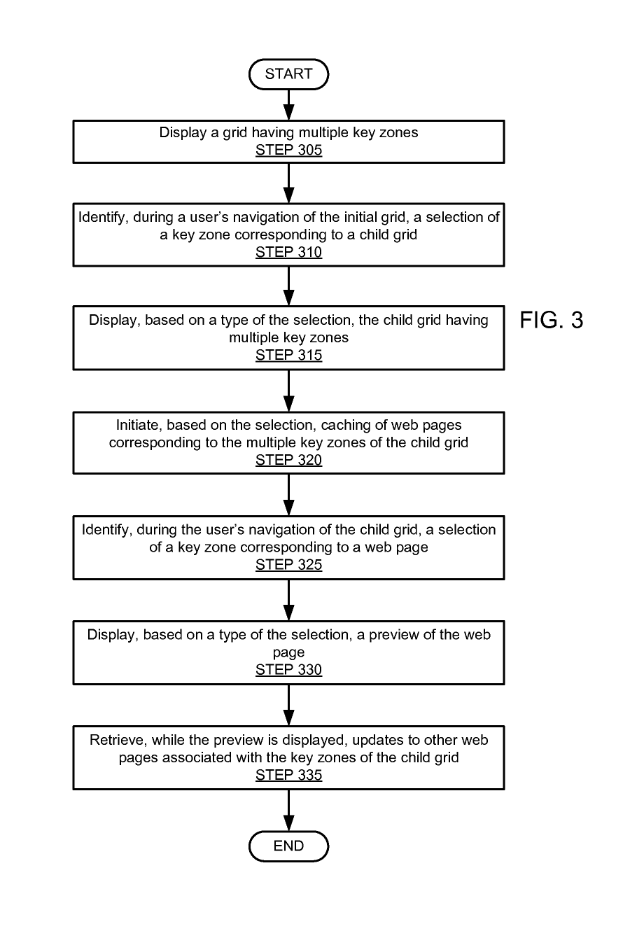

FIG. 3 shows a flowchart in accordance with one or more embodiments of the invention. The process shown in FIG. 3 may be used, for example, with the components of the system (200) to navigate a hierarchy of grids, generate previews of one or more objects corresponding to key zones in the grids, and launch one or more of the objects. The sequence of steps shown in FIG. 3 may differ among embodiments of the invention, and one or more of the steps may be performed in parallel and/or may be optional.

Initially, a grid having multiple key zones is launched (i.e., displayed) (STEP 305). The grid may be displayed within a user interface (e.g., a touch screen) of a user hardware device (i.e., a smart phone). Further, the grid may be a node within a hierarchy (e.g., tree or deck) of grids. In one or more embodiments of the invention, the grid is displayed after the user has traversed one or more levels of the hierarchy to reach the grid. In one or more embodiments of the invention, each key zone of the grid corresponds to a child grid within the hierarchy of grids. In other words, if the displayed grid is located at level N of the tree, the key zones of the grid correspond to grids at level N+1 of the hierarchy.

In one or more embodiments of the invention, each key zone may include (i.e., display) density metrics relating to the child grids, grandchild grids, great grandchild grid, etc. of the displayed grid. Further, one or more key zones may include (i.e., display) the level of the grid within the hierarchy. Further still, either the key zones themselves or areas in close proximity to the key zones (i.e., above, beside, below the key zones) may display indications relating to the objects of novelties, unread content, paths through the grid hierarchy already explored or not yet explored, etc. Moreover, the grid may be displayed with a home grid button to facilitate a return to the root/home grid (i.e., Level 1 grid) of the hierarchy of grids.

In STEP 310, a selection of a key zone is identified. In one or more embodiments of the invention, the key zone corresponds to a child grid having multiple key zones corresponding to multiple objects (e.g., web pages). As discussed above, there exists many selection types and the manner in which the key zone is selected (i.e., selection type) determines the subsequent action involving the child grid. For example, a preview of the child grid may be displayed in response to a user pressing and holding the key zone (i.e., key zone hold). As yet another example, the child grid is launched (i.e., displayed) in response to a user releasing a key zone (i.e., key zone release) after pressing and holding the key zone. In one or more embodiments of the invention, the key zone is selected while the user is surfing (discussed below) the grid.

In STEP 315, the child grid is launched. STEP 315 may be triggered by the selection of the key zone in STEP 310. Alternatively, STEP 315 may be triggered by a subsequent user selection of the key zone following the selection of the key zone in STEP 310. In fact, a preview of the child grid may be displayed in response to STEP 310, while STEP 315 is triggered by a user selection (e.g., key zone release) of the key zone following the display of the preview. As discussed above, the child grid includes multiple key zones corresponding to multiple objects (e.g., web pages, files, commands, maps, advertisements, user software, etc.) In one or more embodiments of the invention, the child grid may be a leaf grid of the hierarchy (i.e., tree). In other words, the child grid may correspond to the last level in the grid hierarchy.

In STEP 320, the objects (e.g., web pages) corresponding to the key zones of the child grid are cached. Specifically, in the case of a web page, the web page is accessed and the latest content on the web page is retrieved (e.g., using the caching module (230), discussed above in reference to FIG. 2). In one or more embodiments of the invention, the trigger for STEP 320 is the same as the trigger for STEP 315. Alternatively, the selection in STEP 310 may be the trigger of STEP 320. Accordingly, depending on the embodiment, STEP 320 may be executed before, during, or after STEP 315.

Once the child grid is launched (i.e., STEP 315), it is available for navigation by the user. In one or more embodiments of the invention, launching the child grid include replacing the parent grid under the user's finger/pointer with the child grid. During navigation, the user may select one or more key zones of the child grid and view previews of the corresponding objects (e.g., web pages). The user may select multiple key zones while surfing the child grid. In other words, the user may trace (i.e., using a finger or stylus) a path within the grid crossing one or more of the multiple key zones. During the trace, a pause on a key zone may be identified as a selection of the key zone (i.e., key zone hold), and the preview of the corresponding object may be displayed in response to the selection. Alternatively, the one or more key zones may be navigated using a touchpad. As yet another alternative, the user may skip the surfing/navigation and immediately select the desired key zone.

In STEP 325, a selection of a key zone in the child grid is identified. The key zone may correspond to a web page. Further, the selection may take place while the user is surfing the child grid. As discussed above, there exists many selection types and the manner in which the key zone is selected (i.e., selection type) determines the subsequent action involving the web page. In STEP 330, a preview for the web page is displayed in response to the selection of the key zone. The preview may correspond to a cached version of the web page. Further, the preview may include only a portion of the web page and/or a low resolution version of the web page.

In STEP 335, updates to the objects (i.e., web pages) associated with other (non-selected) key zones of the child grid are retrieved. In other words, while the preview of the web page is being displayed (i.e., STEP 330), the web pages associated with the other (non-selected) key zones are accessed and the latest content is retrieved. Accordingly, in the event the user selects a different key zone, the preview for the corresponding web page will include the updates. Updates may be retrieved at regular intervals or randomly using a random number generator. Updates may also occur by profiling user habits.

For example, assume the child grid has key zone M corresponding to web page M, and key zone P corresponding to web page P. The user initially selects key zone M, and in response a preview for web page M is displayed. Then, the user selects key zone P, and in response a preview for web page P is displayed. While the preview for web page P is being displayed, web page M may be accessed and the latest content (i.e., updates to web page M) may be retrieved. In the event the user then selects (again) key zone M, the preview for web page M will include the retrieved updates.

Although not explicitly shown in FIG. 3, after viewing one or more previews, the user may request that a web page be launched.

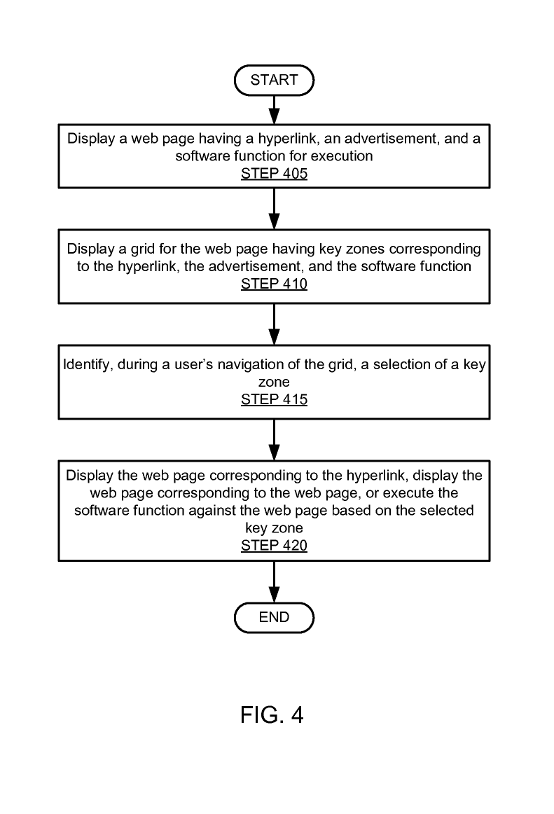

FIG. 4 shows a flowchart in accordance with one or more embodiments of the invention. The process shown in FIG. 4 may be used, for example, with the components of the system (200) to access and/or control the contents of a web site using a grid. The sequence of steps shown in FIG. 4 may differ among embodiments of the invention, and one or more of the steps may be performed in parallel and/or may be optional.

In STEP 405, a web page is displayed. In one or more embodiments of the invention, the web page corresponds to the web page discussed above in reference to STEP 325 and STEP 330 of FIG. 3.

In one or more embodiments of the invention, the web page has one or more hyperlinks. The hyperlinks may reference different web pages from the same site, or web pages from different web sites. User selection of the hyperlinks results in the referenced web pages being launched.

In one or more embodiments of the invention, the web page has one or more software applications. Each software application is a tool that can be executed against the contents of the web page. Further, each software application may rely on parameters provided by the user. Accordingly, the user may control execution of the software application against the content of the web page.

In one or more embodiments of the invention, the web page has one or more advertisements. The advertisements may correspond to images, text, hyperlinks to the advertiser(s) web site(s), video clips, audio clips, animation, etc. presented on the web page. The advertisements may come from the web page or from an advertisement engine (e.g., advertisement engine (235), discussed above in reference to FIG. 2).

In STEP 410, a grid corresponding to the web page is displayed with the web page. Specifically, the grid includes multiple key zones corresponding to the one or more hyperlinks, advertisements, and/or software applications of the web page. In other words, the hyperlinks, advertisements, and/or software applications are assigned to the key zones of the grid. Accordingly, each key zone may include a graphic/icon for identifying the corresponding hyperlink, software function, and/or advertisement on the web page. The grid may be provided with the web page by the author(s) of the web page. Accordingly, the markup language of the web page may include a link (e.g., URL) referencing the grid. Alternatively, the grid may be provided by a third-party for assistance in viewing/accessing the content of the web page.

In STEP 415, a selection of a key zone in the grid is identified. The selection may correspond to a user pressing and holding the key zone (i.e., key zone hold), the user releasing the key zone (after pressing the key zone) (i.e., key zone release), a click from a pointing device (i.e., trackball, mouse, stylus, pen, etc.), a voice command, etc.

In STEP 420, the object of the web page and corresponding to the selected key zone is launched. For example, in the case of a hyperlink, the referenced web page is launched (or even previewed depending on the selection type). In the case of an advertisement, the image, video clip, audio clip, etc. is displayed/played. Further, the web page of the advertiser may be launched in response to the selection of the key zone. Further still, in the case of a software application, the software application is executed against the content of the web site using the parameters (if any) provided by the user. Moreover, the content and the appearance of the web site may change as a result of executing the software application.

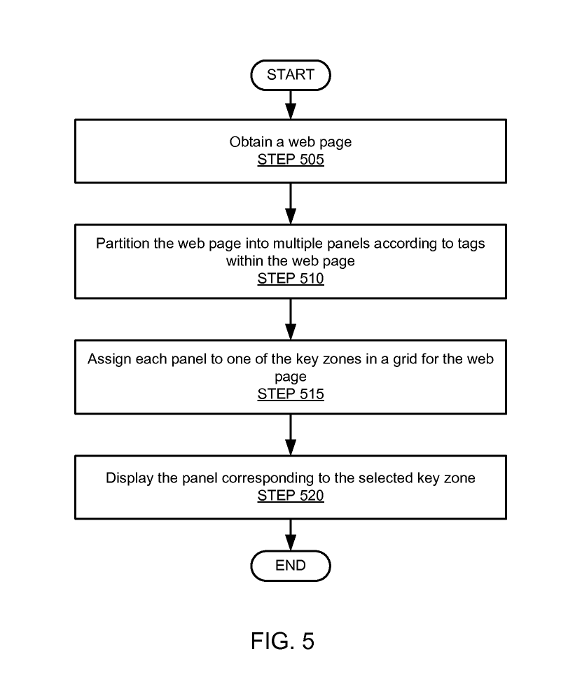

FIG. 5 shows a flowchart in accordance with one or more embodiments of the invention. The process shown in FIG. 5 may be used, for example, with the components of the system (200) (e.g., the partitioning module (220)) to partition a web site into panels and display one or more of the panels using a grid. The sequence of steps shown in FIG. 5 may differ among embodiments of the invention, and one or more of the steps may be performed in parallel and/or may be optional.

In STEP 505, a web page is obtained. In one or more embodiments of the invention, one or more dimensions of the web page exceed the size of the user interface (e.g., touch screen) of the user device (e.g., smart phone). The web page may have any type of content and may originate from any source. In one or more embodiments of the invention, the web page corresponds to the web page discussed above in reference to STEP 325 and STEP 330 of FIG. 3.

In STEP 510, the web page is partitioned into multiple panels. Each panel has one or more dimensions that are smaller than the dimensions of the user interface. In one or more embodiments of the invention, the boundary (i.e., perimeter) of each panel is specified using tags within the markup language (e.g., HTML, XML) describing the web page. The web page may be partitioned in response to assessing the dimensions of the user interface. One of the panels may be designated as the default panel to be initially displayed when the web page is launched.

In STEP 515, a grid having multiple key zones is obtained. Each panel is assigned to one of the multiple key zones. Accordingly, a key zone may have an image or an icon depicting the portion of the web page (i.e., panel) associated with the key zone. In one or more embodiments of the invention, the grid may be provided by the author(s) of the web page. Accordingly, the web page may include tags with a URL referencing the grid.

In STEP 520, a selection of a key zone is identified. The selection may correspond to a user pressing and holding the key zone (i.e., key zone hold), the user releasing the key zone (after pressing the key zone) (i.e., key zone release), a click from a pointing device (i.e., trackball, mouse, stylus, pen, etc.), a voice command, etc. Further, in response to the selection the panel corresponding to the selected key zone is displayed within the user interface.

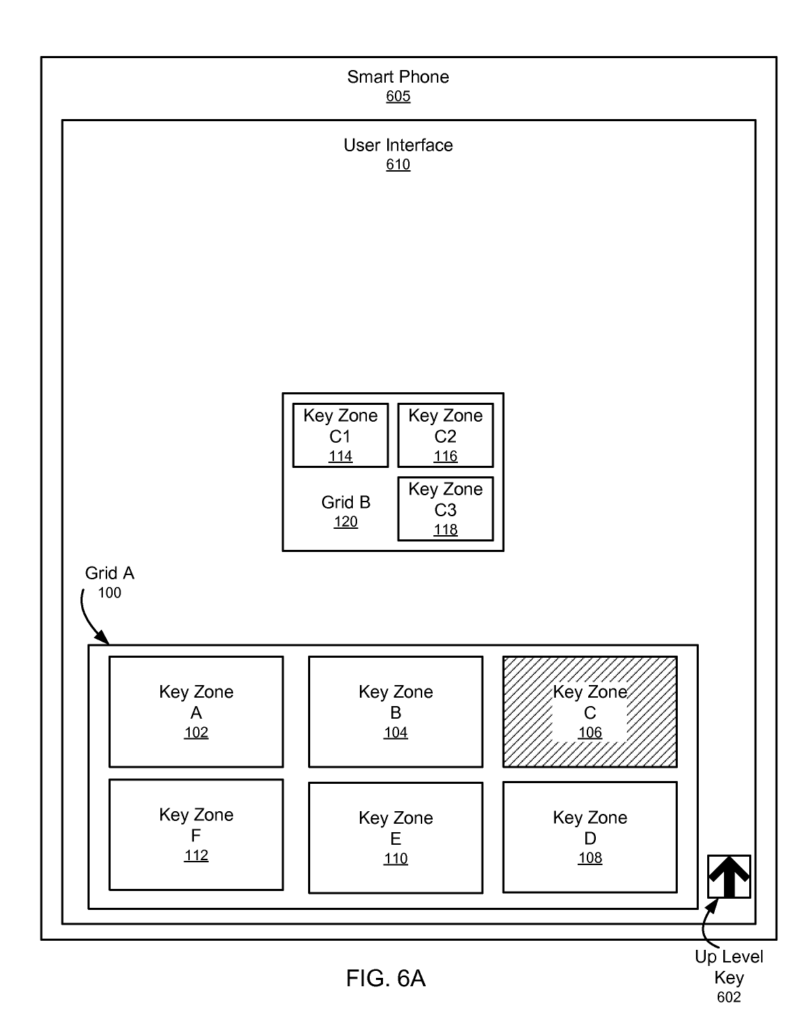

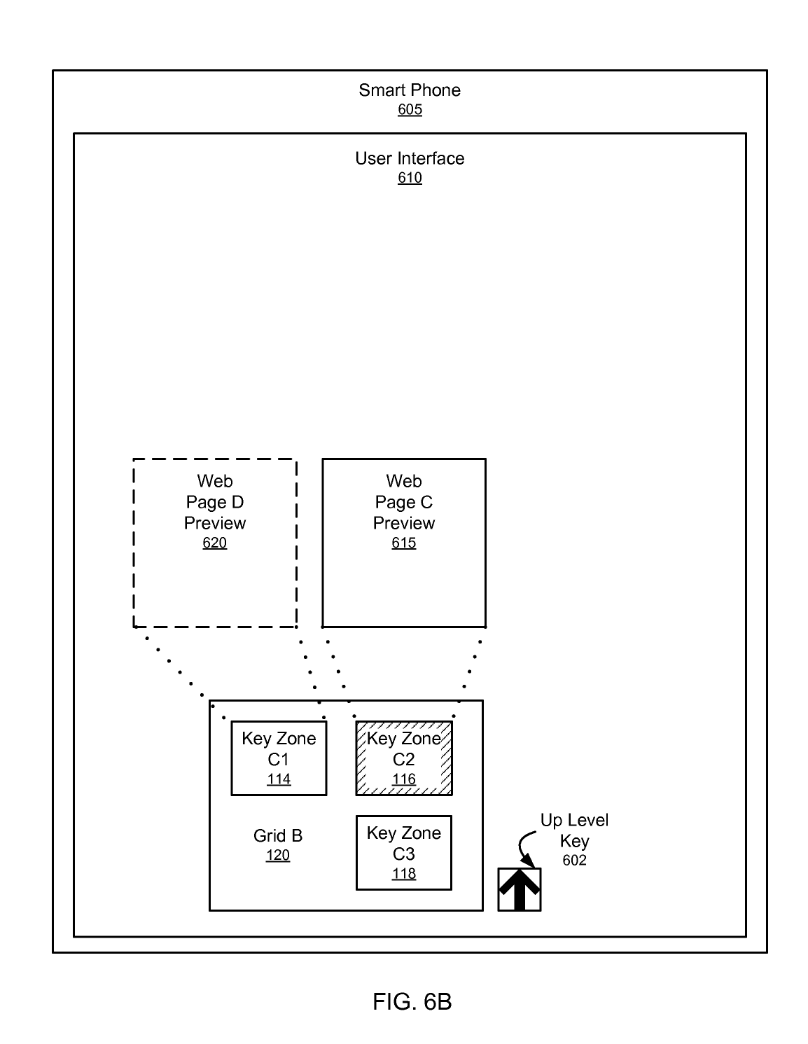

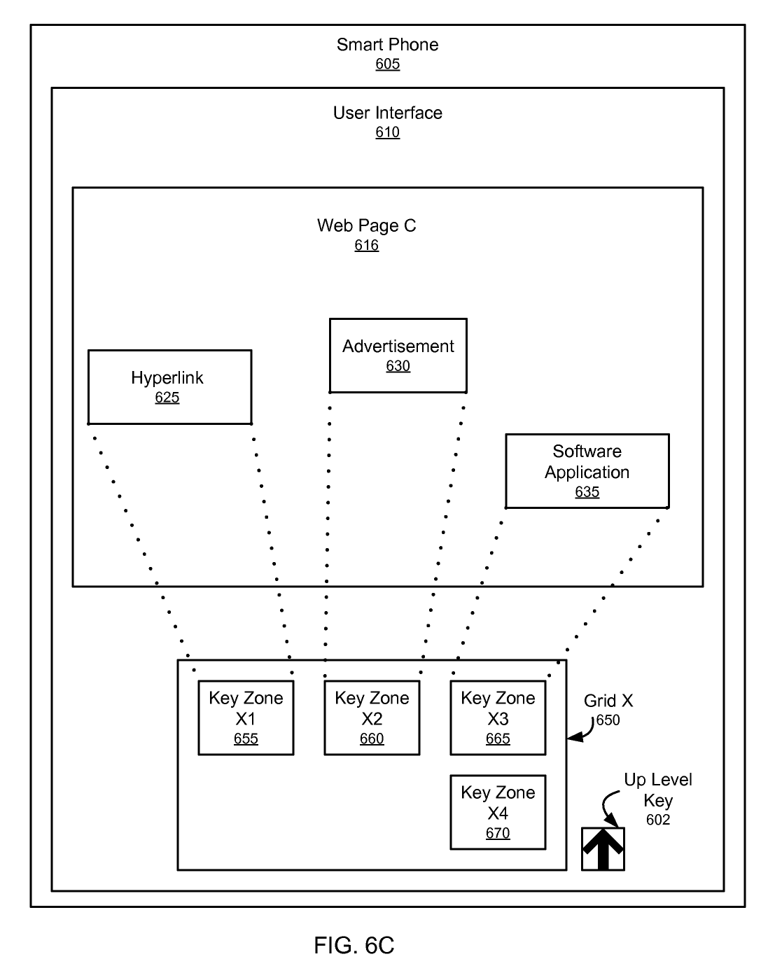

FIG. 6A shows an example in accordance with one or more embodiments of the invention. As shown in FIG. 6A, there exists a smart phone (605) having a user interface (610). The user interface (610) may correspond to any portion of the smart phone's touch screen. As also shown in FIG. 6A, Grid A (100) is displayed within the user interface (610). Further, Grid A (100) includes multiple key zones (i.e., Key Zone A (102), Key Zone B (104), Key Zone C (106), Key Zone D (108), Key Zone E (110), and Key Zone F (112)). The multiple key zones (102, 104, 106, 108, 110, 112) correspond to multiple objects of the same or different type.

Still referring to FIG. 6A, Key Zone C (106) is selected by the user. This selection is denoted within FIG. 6A using diagonal lines across Key Zone C (106). Further, the selection may be the result of the user pressing and holding Key Zone C (106) (i.e., key zone hold). In response to the selection of Key Zone C (106), a preview of Grid B (120) is displayed. In other words, Grid B (120) is the object associated with Key Zone C (106), and the preview of Grid B (120) is displayed in response to the manner in which Key Zone C (106) was selected (i.e., selection type). As shown in FIG. 6A, Grid B (120) has multiple key zones (i.e., Key Zone C1 (114), Key Zone C2 (116), Key Zone C3 (118)).

Both Grid A (100) and Grid B (120) exist within a hierarchy (i.e., tree or deck) of grids. However, Grid A (100) and Grid B (120) are on different levels of the hierarchy of grids. Specifically, Grid B (120) is a child grid of Grid A (100). Conversely, Grid A (100) is a parent grid of Grid B (120). Further, Grid A (100) is a child grid of another grid (not shown) in the hierarchy. The Up Level Key (602) allows the user to go up a level in the hierarchy. In other words, the parent grid of Grid A (100) would be launched (i.e., displayed) in response to a selection of the Up Level Key (602). In one or more embodiments of the invention, the level of Gird A (100) within the hierarchy of grids is displayed within the Up Level Key (602).

FIG. 6B shows an example in accordance with one or more embodiments of the invention. Specifically, FIG. 6B corresponds to the scenario where the user has selected to launch Grid B (120). Accordingly, Grid B (120) has replaced Grid A (100) in the user interface (610). The user can access Grid A (110) by selecting the Up Level Key (602). In one or more embodiments of the invention, the level of Grid B (120) within the hierarchy of grids is displayed within the Up Level Key (602).

As shown in FIG. 6B, Grid B (120) includes multiple Key Zones (114, 116, 118). Further, the key zones (114, 116, 118) correspond to web pages from the same or different web sites. For example, Key Zone C1 (114) corresponds to Web Page D (not shown). Similarly, Key Zone C2 (116) corresponds to Web Page C (not shown). Key Zone C2 (116) is selected by the user. The selection is denoted within FIG. 6B using diagonal lines across Key Zone C2 (116). Further, the selection may be the result of the user pressing and holding Key Zone C2 (116) (i.e., key zone hold). In response to the selection of Key Zone C2 (116), a preview of Web Page C (615) is displayed. While the preview of Web Page C (615) is displayed, web page D may be accessed and the latest content may be retrieved. Accordingly, when the user subsequently selects Key Zone C1 (114), the preview of Web Page D (620) will include the recently retrieved updates.

Once Grid B (120) is launched, it is available for navigation by the user. Specifically, the user may select one or more key zones (114, 116, 118) to view previews (615, 620) of the corresponding web pages. The user may select multiple key zones while surfing Grid B (120). In other words, the user may trace (i.e., using a finger or stylus) a path within Grid B (120) crossing one or more of the multiple key zones (114, 116, 118). During the trace, a pause on a key zone may be identified as a selection of the key zone (i.e., key zone hold), and the preview of the corresponding web page may be displayed in response to the selection. During the trace, the user need not lift the finger or stylus off the user interface (610). The scenarios depicted by FIG. 6A and FIG. 6B may be tied to the process described in FIG. 3.

FIG. 6C shows an example in accordance with one or more embodiments of the invention. Specifically, FIG. 6C corresponds to the scenario where the user has selected to launch Web Page C (616) (e.g., by selecting Key Zone C2 (116) shown in FIG. 6B using a key zone release). Accordingly, Web Page C (616) is displayed in the user interface (610). Grid X (650) is also displayed with the Web Page C (616) in the user interface (610). Selection of the Level Up Key (602) allows the user to return to Grid B (120). In one or more embodiments of the invention, the level of Grid X (650) within the hierarchy of grids is displayed within the Up Level Key (602).

As shown in FIG. 6C, the Web Page C (616) includes a hyperlink (625), an advertisement (630), and a software application (636). The hyperlink (625) may reference a web page from the same site as Web Page C (615), or a web page from a different web site. The software application (635) may be a tool for execution by the user against the content of Web Page C (616). Further, the software application may execute based on parameters provided by the user. The advertisement (630) may correspond to an image, a hyperlink, a video clip, an audio clip, an animation, etc.

Grid X (650) may be provided by the creator/author(s) of Web Site C (616) or by a third-party for assistance in accessing the content of Web Site C (616). As shown in FIG. 6C, Grid X (650) includes multiple key zones (i.e., Key Zone X1 (655), Key Zone X2 (660), Key Zone X3 (665), Key Zone X4 (670)). As shown in FIG. 6C, the hyperlink (625), the advertisement (630), and the software application (635) are assigned to key zones (655, 660, 665), respectively. In one or more embodiments of the invention, Key Zone X4 (670) may also correspond to an advertisement (e.g., an advertisement selected by the advertisement engine (235), discussed above in reference to FIG. 2).

Following a selection of a key zone in Grid X (650), the corresponding object is launched. For example, in the case of the hyperlink (625), the referenced web page is launched (or even previewed depending on the selection type). In the case of the advertisement (630), the image, video clip, audio clip, etc. is displayed/played. Further, the web page of the advertiser may be launched. In the case of the software application (635), the software application is executed against the content of Web Page C (616) based on the parameters (if any) provided by the user. Moreover, the content and the appearance of Web Site C (616) may change as a result of executing the software application. The scenario(s) depicted by FIG. 6C may be tied to the process described in FIG. 4.

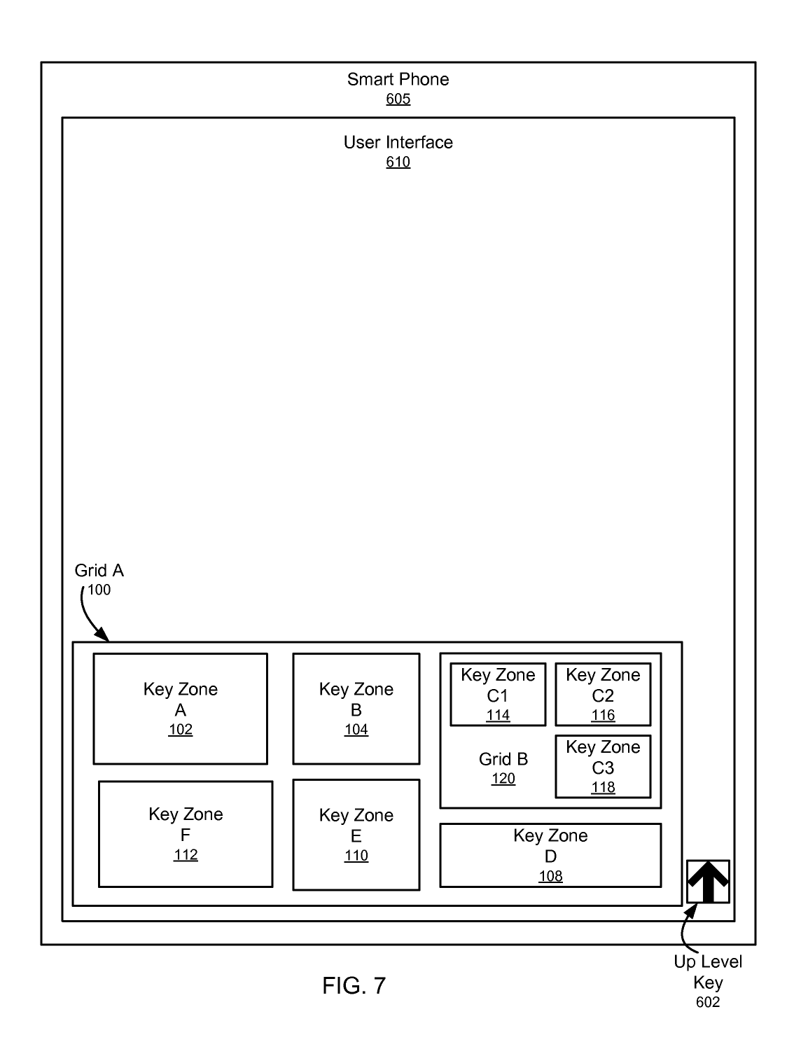

FIG. 7 shows an example in accordance with one or more embodiments of the invention. Specifically, FIG. 7 depicts the scenario where the user has selected Key Zone C (106) (e.g., key zone hold), discussed above in reference to FIG. 6A, and in response a preview of Grid B (120) is displayed. As shown in FIG. 7, the preview of Grid B (120) has been generated by replacing Key Zone C (106) in Grid A (100) with a scaled version of Grid B (120) Further, one or more of the other key zones (102, 104, 108, 110, 112) in Grid A (100) are reduced in size to clearly display the scaled version of Grid B (120). The user may select Up Level Key (602) to return to the regular display of Grid A (100).

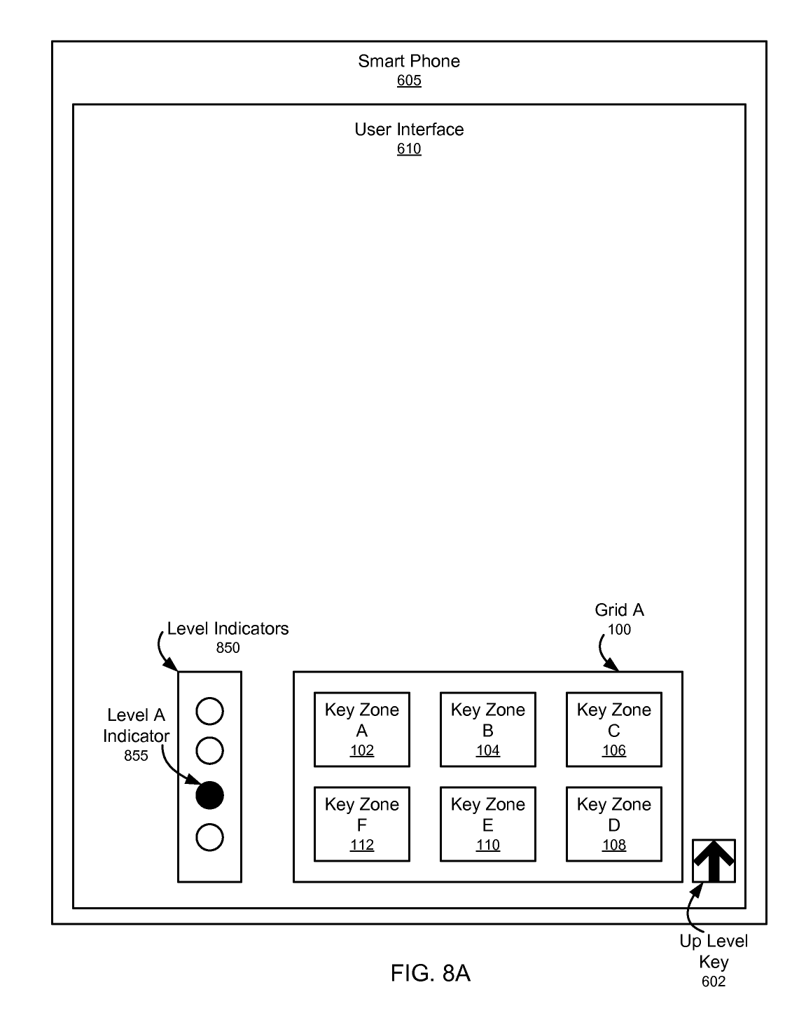

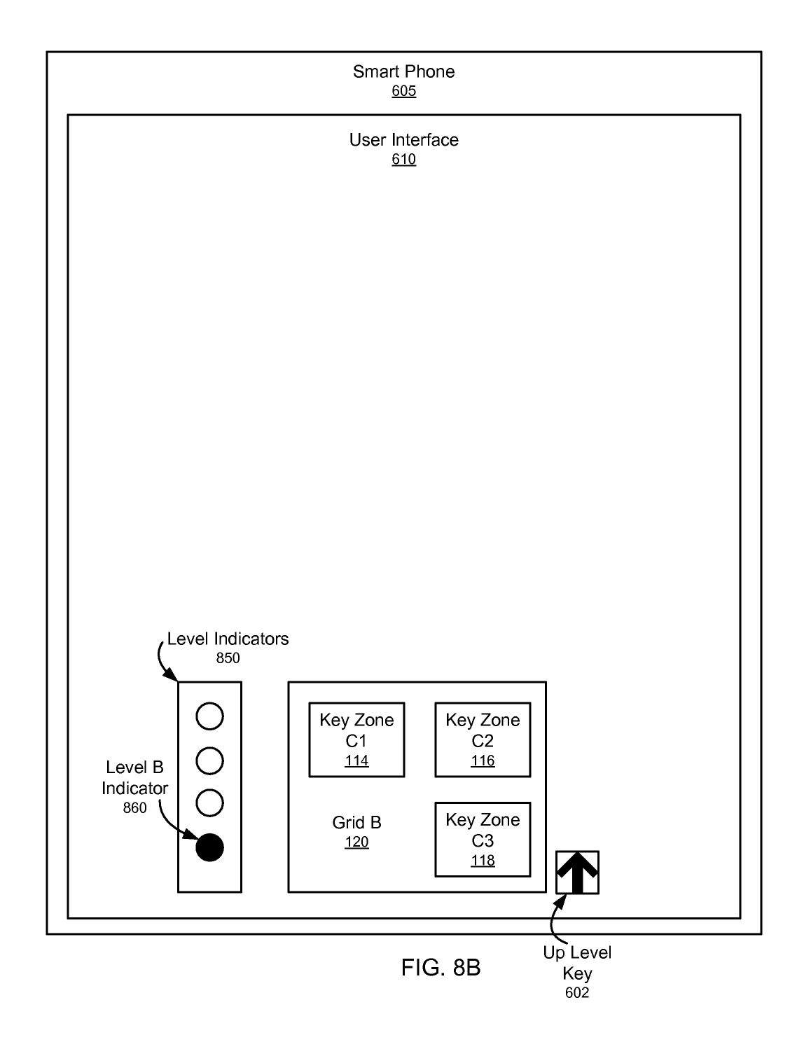

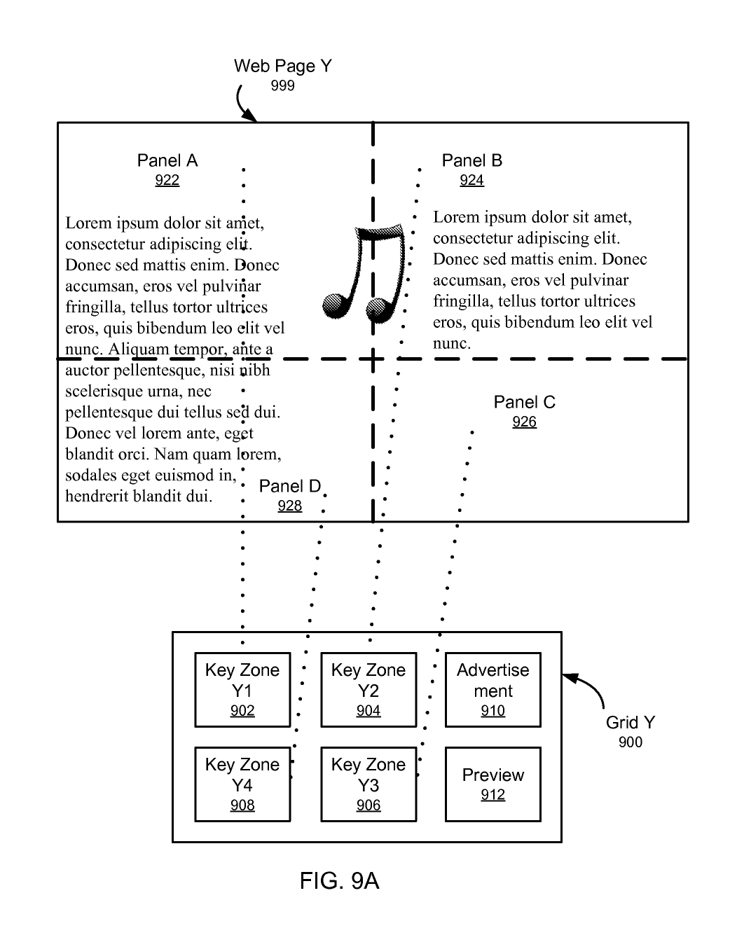

FIG. 8A shows an example in accordance with one or more embodiments of the invention. In the scenario depicted in FIG. 8A, level indicators (850) are displayed with Grid A (100). As discussed above, Grid A (100) may be a grid in a hierarchy (i.e., tree or deck) of grids. Further, the hierarchy of grids may have any number of levels. The level indicators (850) are used to convey the level of the hierarchy in which a grid resides. For example, in FIG. 8A, Level A Indicator (855) is set in response to displaying Grid A (100). FIG. 8B shows an example in accordance with one or more embodiments of the invention. In FIG. 8B, Level B Indicator (860) is set in response to displaying Grid B (120). As Level A Indicator (855) is higher than Level B Indicator (860), this conveys that Grid A (100) is higher in the hierarchy of grids than Grid B (120).

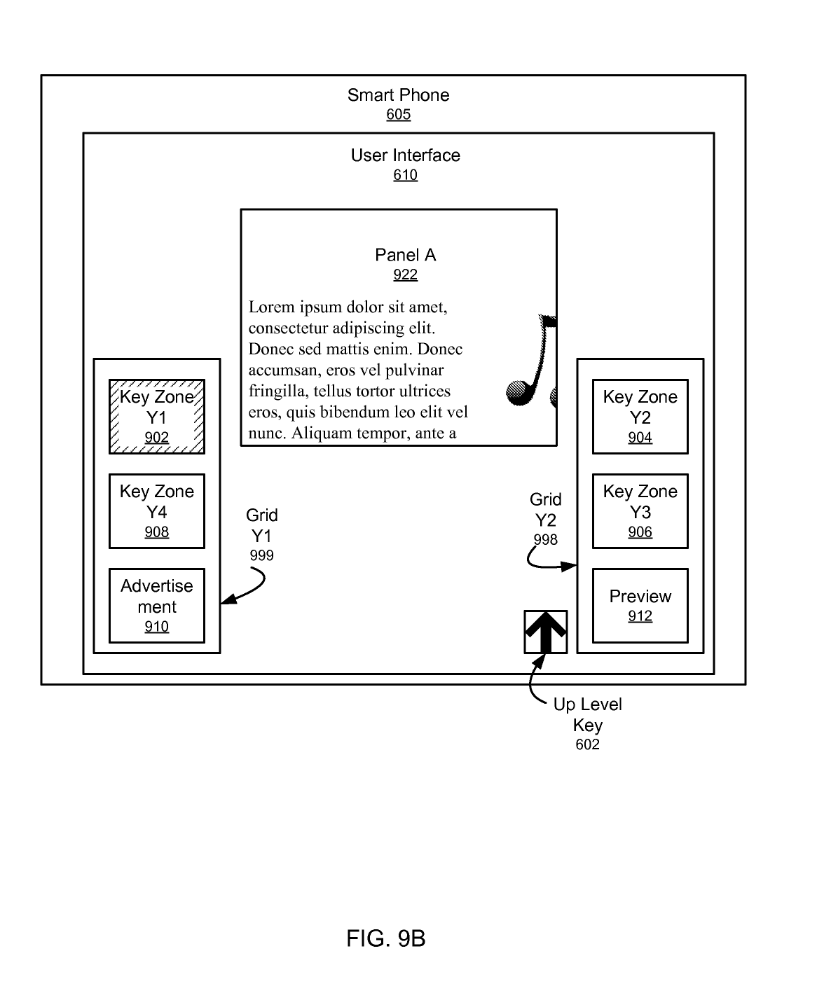

FIG. 9A shows an example in accordance with one or more embodiments of the invention. As shown in FIG. 9A, there exists a large web page (i.e., Web Page Y (999)) and a grid (i.e., Grid Y (900)). Web Page Y (999) includes one or more tags defining the boundaries (i.e., perimeter) of multiple panels (i.e., Panel A (922), Panel B (924), Panel C (926) and Panel D (928)). The panels (922, 924, 926, 928) effectively partition Web Page Y (999).

As also shown in FIG. 9A, Grid Y (900) has multiple key zones (i.e., Key Zone Y1 (902), Key Zone Y2 (904), Key Zone Y3 (906), Key Zone Y4 (908), Advertisement (910), Preview (912). Each panel (922, 924, 926, 928) is assigned to one of the key zones (902, 904, 906, 908). For example, Panel A (922) is assigned to Key Zone Y1 (902). Similarly, Panel D (928) is assigned to Key Zone Y4 (908). Those skilled in the art, having the benefit of this detailed description, will appreciate that the key zones corresponding to panels (i.e., Key Zone Y1 (902), Key Zone Y2 (904), Key Zone Y3 (906), Key Zone Y4 (908)) are arranged to patch the layout of the panels (922, 924, 926, 928). For example, Key Zone Y4 (908) is below Key Zone Y1 (902), just like Panel D (928) is below Panel A (922).

As also shown in FIG. 9A, the right-hand side of Grid Y (900) includes two reserved key zones: the advertisement key zone (910) and the preview key zone (912). The advertisement key zone (910) is populated with an advertisement (e.g., an advertisement selected by the Advertisement Engine (235), discussed above in reference to FIG. 2). Upon selection of the advertisement key zone (910), the advertisement is launched. In contrast, upon selection of the preview key zone (912), a scaled (i.e., reduced) version of the full web page Y (1099) is displayed. Those skilled in the art, having the benefit of this detailed description, will appreciate that other special/reserved key zones may take the place of the advertisement key zone (910) and/or the preview key zone (912).

FIG. 9B shows an example in accordance with one or more embodiments of the invention. As shown in FIG. 9B, Grid Y (900) is split into two grids: Grid Y1 (999) and Grid Y2 (998), each having a single column. Any grid may be split as shown in FIG. 9B. Grid Y1 (999) and Grid Y2 (998) are displayed on opposite sides of the user interface (610) (e.g., below each of the user's hands). Further, Key Zone Y1 (902) is selected by the user (i.e., denoted using diagonal lines across Key Zone Y1 (902)). In response to the selection of Key Zone Y1 (902), Panel A (922) is displayed. As also shown in FIG. 9B, the dimensions of Panel A (922) are less than the dimensions of the user interface (610). Accordingly, large Web Site Y (999) may successfully be displayed within the constraints of the smart phone (605) by partitioning the Web Site Y (999) into panels and then making the panels available for access using Grid Y (900). The scenario(s) depicted by FIG. 9A and 9B may be tied to the process described in FIG. 5.

Although FIGS. 8-10 are heavy focused on the smart phone (605) having the touch screen user interface (610), those skill in the art, having the benefits of this detailed description, will appreciate the examples are equally valid using other types of user hardware devices (e.g., kiosks, cable boxes, televisions, desktop computers, etc.). Key zones selections may be accomplished using a touch screen, a keyboard/keypad, a pointing device (i.e., mouse, trackball), voice commands, etc.

Although FIGS. 6-9 are heavily focused on the existence of the Up Level Keys (602), those skilled in the art, having the benefit of this detailed description, will appreciate that there exists other methods for navigation to a parent grid. For example, a user may slide a finger or stylus outside the current grid and then release the finger or stylus to navigate to the parent grid.

Embodiments of the invention have one or more of the following advantages: the ability to provide a user interface suitable for the constraints of a mobile device (e.g., smaller screen size, fewer commands, slower connection to the Internet, etc.); the ability to organize and quickly access views of the web; the ability to store, share, manage, and quickly access (i.e., surf) links to web pages; the ability to organize icons and/or menu features that are frequently accessed; the ability to reduce the time spent searching, navigating, exploring, going back, trying again, and finally acquiring desired content from the web; the ability to share content (e.g., web pages, grids) with other users; the ability to reduce time spent jumping between frequently accessed web pages; etc..

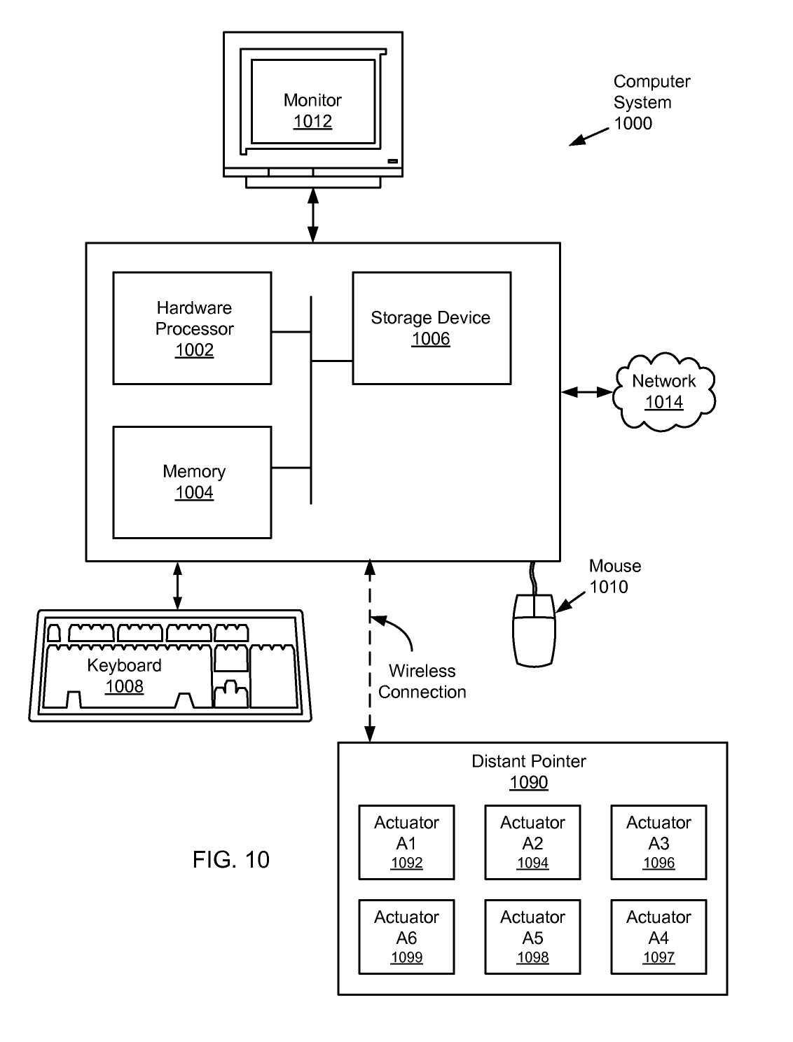

Embodiments of the invention may be implemented on virtually any type of computer (including mobile computers) regardless of the platform being used. For example, as shown in FIG. 10, computer system (1000) includes one or more processor(s) (1002), associated memory (1004) (e.g. random access memory (RAM), cache memory, flash memory, etc.), storage device (1006) (e.g. a hard disk, an optical drive such as a compact disk drive or digital video disk (DVD) drive, a flash memory stick, etc.), and numerous other elements and functionalities typical of today's computers (not shown). In one or more embodiments of the invention, processor (1002) is hardware. For example, the processor may be an integrated circuit. Computer system (1000) may also include input means, such as keyboard (1008), mouse (1010), or a microphone (not shown). Further, computer system (1000) may include output means, such as monitor (1012) (e.g. a liquid crystal display (LCD), a plasma display, or cathode ray tube (CRT) monitor). Computer system (1000) may be connected to network (1014) (e.g. a local area network (LAN), a wide area network (WAN) such as the Internet, or any other type of network) via a network interface connection (not shown). In one or more embodiments of the invention, many different types of computer systems exist, and the aforementioned input and output means may take other forms. Generally speaking, computer system (1000) includes at least the minimal processing, input, and/or output means necessary to practice embodiments of the invention.

Further, in one or more embodiments of the invention, one or more elements of the aforementioned computer system (1000) may be located at a remote location and connected to the other elements over a network. Further, embodiments of the invention may be implemented on a distributed system having a plurality of nodes, where each portion of the invention (e.g. data structure, converter module, layout engine) may be located on a different node within the distributed system. In one embodiment of the invention, the node corresponds to a computer system. Alternatively, the node may correspond to a processor with associated physical memory. The node may alternatively correspond to a processor or micro-core of a processor with shared memory and/or resources. Further, software instructions in the form of computer readable program code to perform embodiments of the invention may be stored, temporarily or permanently, on a non-transitory computer readable storage medium, such as a compact disc (CD), a diskette, punch cards, a tape, a memory stick, a flash drive, or any other computer readable storage device.

In one or more embodiments of the invention, the computer system (1000) includes a distant pointer (1090) which is wirelessly connected to the rest of the computer system (1000). As shown in FIG. 11, the distance pointer (1090) includes multiple actuators (i.e., Actuator A1 (1092), Actuator A2 (1094), Actuator A3 (1096), Actuator A4 (1097), Actuator A5 (1098), Actuator A6 (1099)). The distant pointer (1090) is a hardware device that acts as a remote control. The actuators (1092, 1094, 1096, 1097, 1098, 1099) correspond to the key zones displayed on the monitor (1012). Accordingly, the user may remotely select the key zones displayed on the monitor (1012) using the actuators (1092, 1094, 1096, 1097, 1098, 1099) of the distant pointer (1090).

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method, comprising:
displaying, within a user interface (UI), a first grid comprising a first plurality of key zones corresponding to a first plurality of objects;
identifying a selection of a first key zone in the first plurality of key zones corresponding to an object of the first plurality of objects, wherein the selection of the first key zone is a first type of selection;
displaying, within the UI and in response to the selection of the first key zone, a second grid comprising a second plurality of key zones corresponding to a second plurality of objects, wherein the object of the first plurality of objects is associated with the second grid;
receiving a first selection of a second key zone in the second plurality of key zones, wherein the first selection of the second key zone is a second type of selection; and
displaying, within the UI and in response to the first selection of the second key zone, a first preview of a first web page with the second grid,
wherein the first web page corresponds to an object in the second plurality of objects.

2. The method of claim 1, wherein the first type of selection is a key zone release, and wherein the second type of selection is a key zone hold.

3. The method of claim 1, further comprising:
reducing, within the UI, an area of at least one of the first plurality of key zones; and
replacing, within the UI, the first key zone with a scaled version of the second grid to generate a preview of the second grid.

4. The method of claim 1, further comprising:
displaying, within the UI and with the first grid, a level indicator corresponding to a level of the first grid; and
displaying, within the UI and with the second grid, a second level indicator corresponding to a level of the second grid.

5. The method of claim 1, further comprising:
caching, in response to the selection of the first key zone, a plurality of previews for the second plurality of objects, wherein the plurality of previews includes the first preview.

6. The method of claim 1, further comprising:
displaying, within the UI and after displaying the first preview, a second preview corresponding to a second object in the second plurality of objects;
retrieving, while displaying the second preview, an update from the first web page;
receiving a second selection of the second key zone after retrieving the update; and
displaying, within the UI and in response to the second selection, the first preview with the update.

7. The method of claim 1, further comprising:
displaying, within the UI, the first web page after displaying the first preview, wherein the first web page corresponds to a web site;
displaying, within the UI and with the first web page, a third grid comprising a third plurality of key zones corresponding to a second web page of the web site and a software function from the web site;
receiving a selection of a third key zone in the third plurality of key zones, wherein the third key zone corresponds to the software function; and
executing, in response to the selection of the third key zone, the software function against at least one selected from a group consisting of the first web page and the second web page.

8. The method of claim 7, wherein at least one of the third plurality of key zones corresponds to an advertisement from the web site.

9. The method of claim 1, further comprising:
obtaining the second grid by accessing a uniform resource locator (URL) referencing the second grid.

10. A computer readable medium storing instructions comprising functionality to:
display, within a user interface (UI), a first grid comprising a first plurality of key zones corresponding to a first plurality of objects;
identify a selection of a first key zone in the first plurality of key zones corresponding to an object of the first plurality of objects, wherein the selection of the first key zone is a first type of selection;
display, within the UI and in response to the selection of the first key zone, a second grid comprising a second plurality of key zones corresponding to a second plurality of objects, wherein the object of the first plurality of objects is associated with the second grid;
receive a first selection of a second key zone in the second plurality of key zones, wherein the first selection of the second key zone is a second type of selection; and
display, within the UI and in response to the first selection of the second key zone, a first preview of a first web page with the second grid,
wherein the first web page corresponds to an object in the second plurality of objects.

11. The computer readable medium of claim 10, the instructions further comprising functionality to:
reduce, within the UI, an area of at least one of the first plurality of key zones; and
replace, within the UI, the first key zone with a scaled version of the second grid to generate a preview of the second grid.

12. The computer readable medium of claim 10, the instructions further comprising functionality to:
display, within the UI and with the first grid, a level indicator corresponding to a level of the first grid; and
display, within the UI and with the second grid, a second level indicator corresponding to a level of the second grid.

13. The computer readable medium of claim 10, the instructions further comprising functionality to:
cache, in response to the selection of the first key zone, a plurality of previews for the second plurality of objects, wherein the plurality of previews includes the first preview.

14. The computer readable medium of claim 10, the instructions further comprising functionality to:
display, within the UI and after displaying the first preview, a second preview corresponding to a second object in the second plurality of objects;
retrieve, while displaying the second preview, an update from the first web page;
receive a second selection of the second key zone after retrieving the update; and
display, within the UI and in response to the second selection, the first preview with the update.

15. The computer readable medium of claim 10, the instructions further comprising functionality to:
display, within the UI, the first web page after displaying the first preview, wherein the first web page corresponds to a web site;
display, within the UI and with the first web page, a third grid comprising a third plurality of key zones corresponding to a second web page of the web site and a software function from the web site;
receive a selection of a third key zone in the third plurality of key zones, wherein the third key zone corresponds to the software function; and
execute, in response to the selection of the third key zone, the software function against at least one selected from a group consisting of the first web page and the second web page.

16. A system comprising:
a grid repository storing a first grid comprising a first plurality of key zones corresponding to a first plurality of objects and a second grid comprising a second plurality of key zones corresponding to a second plurality of objects;
a user event listener configured to identify a selection of a first key zone in the first plurality of key zones and a selection of a second key zone in the second plurality of key zones, wherein the selection of the first key zone is a first type of selection, and wherein the selection of the second key zone is a second type of selection; and
a grid engine configured to display the second grid in response to the selection of the first key zone and to display a preview for a web page in response to the selection of the second key zone,
wherein the second grid corresponds to an object in the first plurality of objects, and
wherein the web page corresponds to an object in the second plurality of objects.

17. The system of claim 16, wherein the first type of selection is a key zone release, and wherein the second type of selection is a key zone hold.

18. The system of claim 16, further comprising:
a caching module configured to identify a frequent path through the first grid and the second grid and cache a plurality of previews for a subset of the first plurality of objects and the second plurality of objects, wherein the plurality of previews comprises the preview for the web page.

19. The system of claim 16, further comprising:
a partitioning module configured to partition the web page into a plurality of panels defined using tags within the web page.

20. The system of claim 16, further comprising:
an advertisement engine configured to select an advertisement to populate a key zone of at least one selected from a group consisting of the first grid and the second grid,
wherein the advertisement is launched in response to a selection of the key zone.
